(19) United States
(12) Patent Application Publication
(10) Pub. No.: US 2007/0063873 A1
(43) Pub. Date: Mar. 22, 2007

(54) Standard

(75) Inventors: James Henry Murray, Alberton (ZA); Alice Susan Johnston, Alberton (ZA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Emerald Sky Trading 330 (Pty) Limited, Alberton (ZA)

(21) Appl. No.: 11/274,033

(22) Filed: Nov. 15, 2005

(30) Foreign Application Priority Data
Aug. 4, 2005 (ZA) 2005/06232

(51) Int. Cl. G08G 1/00; G08G 1/096

(52) U.S. Cl. 340/932

(57) ABSTRACT

This invention relates to an advertising standard which is positionable between vehicle parking bays in a parking lot such that information carried on the standard is visible to occupants of vehicles as they are parked. The standard has at least one information displaying surface and may include an electronic or electromechanical means for changing the information displayed.

### FIELD OF THE INVENTION

This invention relates to a standard, more particularly an advertising standard, for use in vehicle parking lots.

### BACKGROUND TO THE INVENTION

Parking garages and lots tend to have a substantial number of vehicles parked adjacent to and facing one another without any barrier therebetween.

The lack of a barrier can result in a certain degree of annoyance where one vehicle encroaches into the space provided for another. In addition, in large parking garages or lots many parkers get lost because of a lack of easily readable directions. This is particularly true for airport parking lots and large shopping mall parking lots.

In this specification the term “standard” should be read to refer to advertising and/or an information content, other than the military, that is displayed on an upright.

### OBJECT OF THE INVENTION

It is an object of this invention to provide a standard and more particularly to provide a standard having an advertising or information content for use in vehicle parking lots and parking garages.

### SUMMARY OF THE INVENTION

In accordance with this invention there is provided for a standard comprising a base supporting an upright which has a display means located opposite the base, the display means having at least one surface on which information is displayed, the standard being locatable between contiguous vehicle parking bays in a parking area.

There is further provided for the contiguous parking bays to share an edge normally located towards the front of parked vehicles.

There is also provided for the display means to have two opposed surfaces on which information is displayed. Alternatively there is provided for the display means to be cylindrical and have a circular surface on which information is displayed. Further alternatively there is provided for the display means to be parallelepipedical or cuboidal and have five surfaces on which information can be displayed and still further alternatively there is provided for the display means to be triangular in plan view or pyramidical and have four surfaces on which information can be displayed.

There is further provided for the information to include one or more of: position related information in the form of directions and/or a map; communication related information in the form of directions to, for example, a departure and/or arrivals area of an airport or railway station; or advertising or marketing information.

There is also provided for the base of the standard to be secured to a parking area substrate, preferably by means of rawl bolts or anchors or screws and for at least the upright of the standard to have a means, preferably a hinge mechanism, alternatively a spring mechanism, together with a padded or similar cladding or sheath to obviate damage to a vehicle that, accidentally, bump against the standard. Alternatively there is provided for the standard upright to be manufactured of a resiliently flexible material, preferably glass reinforced plastic, and for the standard to be clad with a synthetic, impact resistant, rubber material. As an alternative to the above-described fasteners for securing the base of the standard to a parking area substrate, the base may be secured with a suitable adhesive.

There is also provided for the display means of the standard to have a mechanism for varying the information displayed and for said mechanism to be an endless scroll and driving mechanism, alternatively a means for rotating the display means on the standard upright, further alternatively an electronic image displaying screen.

### BRIEF DESCRIPTION OF THE DRAWINGS

Embodiments of the invention will be described below by way of example only and with reference to the accompanying drawings in which:

FIG. 1 is a front elevation of the embodiment of a standard according to the invention;

FIG. 2 is a perspective view of a second embodiment of a display means according to the invention;

FIG. 3 is a perspective view of a third embodiment of a display means according to the invention;

FIG. 4 is a perspective view of a fourth embodiment of a display means according to the invention;

FIG. 5 is a perspective view of a fifth embodiment of a display means according to the invention; and

FIG. 6 is a second embodiment of a standard base and upright according to the invention.

### DETAILED DESCRIPTION OF THE DRAWINGS

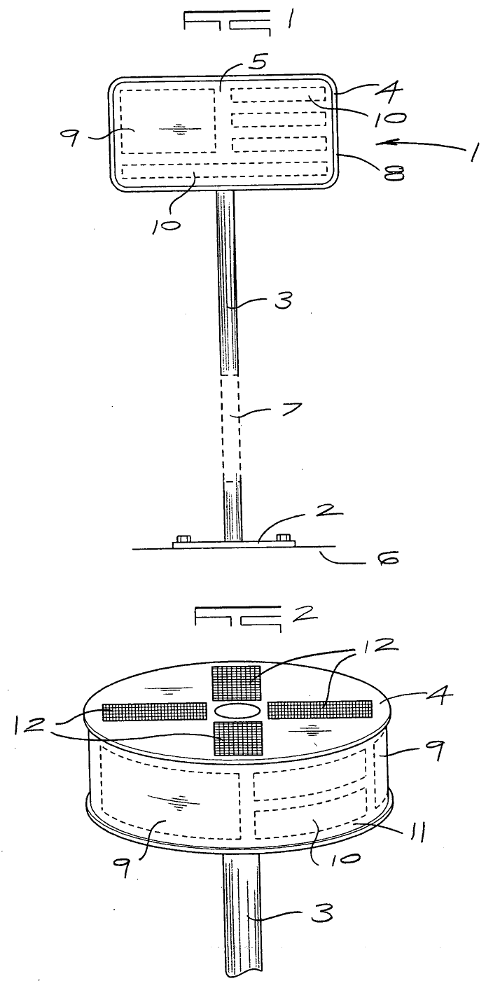

Referring to FIG. 1, a standard (1) comprises a base (2) supporting an upright (3) which has a display means (4) located opposite the base (2). The display means (4) has a pair of opposed information displaying surfaces (5) which only one is shown in the figure. In use, the standard (1) is positioned on the base (2) between adjacent vehicle parking bays in a parking area (6) so that information displayed on the information displaying surfaces (5) is visible to occupants of adjacently parked vehicles (not shown). Preferably the standard (1) is positioned between two “drive-in” type parking bays where the front ends of the parked vehicles face one another. This ensures that a driver of a properly parked vehicle will see the information.

The upright (3) has a spring loaded hinged section (7) which, it is envisaged, will allow the upright (3) and display means (4) to bend when impacted by a motor vehicle and return to the upright position once the impacting vehicle has reversed without causing any damage to the vehicle. In addition and to further guard against damaging an impacting vehicle the upright (3) is clad in an impact absorbent yieldable rubber material (not shown).

The information displaying surfaces (5) are generally planar, clear, plastics material and the display means (4) is in the form of a housing having an elongate slot (not shown) at one of its vertical sides (8) through which an A4 sized board or boards having information printed thereon can be inserted such that, when inserted the board or boards are located within the housing and the information is viewable through the information displaying surfaces (5). The information displayed may be of an advertising nature such as a logo, price list or the like, of an informatory nature such as a map and directions or both. In the embodiment illustrated the information consists of an illustration (9) and written information (10).

It will be appreciated that, because the display means (4) in the embodiment illustrated is double sided, the same or different information can be displayed on each of the two sides.

In the embodiment illustrated in FIG. 1 the base (2) is secured to the parking area (6) by two rawl bolts (10) that are driven through bores in the base (2) into the surface of the parking area (6).

Referring to FIG. 2, an alternate embodiment of a display means (4) is illustrated. In this embodiment the display means (4) is in the form of a rotating disc on which is affixed to the upright (3). The drum (4) has transparent, plastic material sides (11) and houses a circular banner with graphic material (9) and written material (10).

The drum (4) also houses a mechanism (not shown) which causes it to rotate. In the embodiment illustrated the mechanism (not shown) is an electric motor powered by a rechargeable battery which is charged by solar cells (12) located on the operatively upper surface of the drum (4). The drum (4) is mounted, on bearings (not shown) on the support (3) and an arrangement of gears (not shown) causes the drum (4) to rotate about the support (3).

A clockwork motor could be used as an alternative to the electric motor.

It will be appreciated that the rotating drum will enable a number of different information displays to be presented. In addition and as an alternative to a cylindrical drum as illustrated, the drum may be polygonal having a number of planar faces.

As a further alternative to the above-described embodiments of a display means, the display means may be configured to display information electronically where the displaying surface is a liquid crystal display screen. With such a display information, for example aircraft or train arrival and departure times, can be updated regularly.

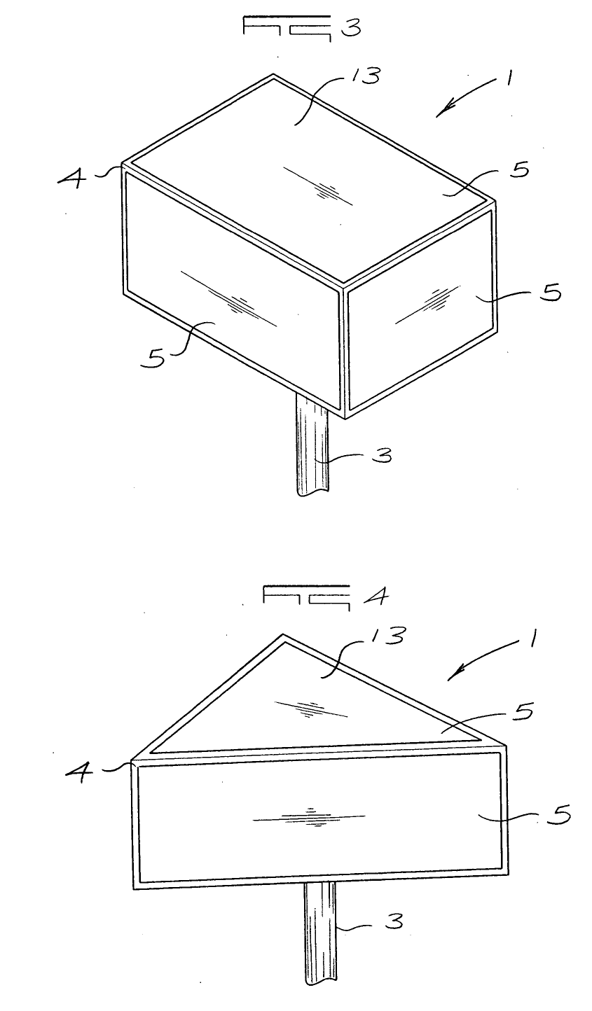

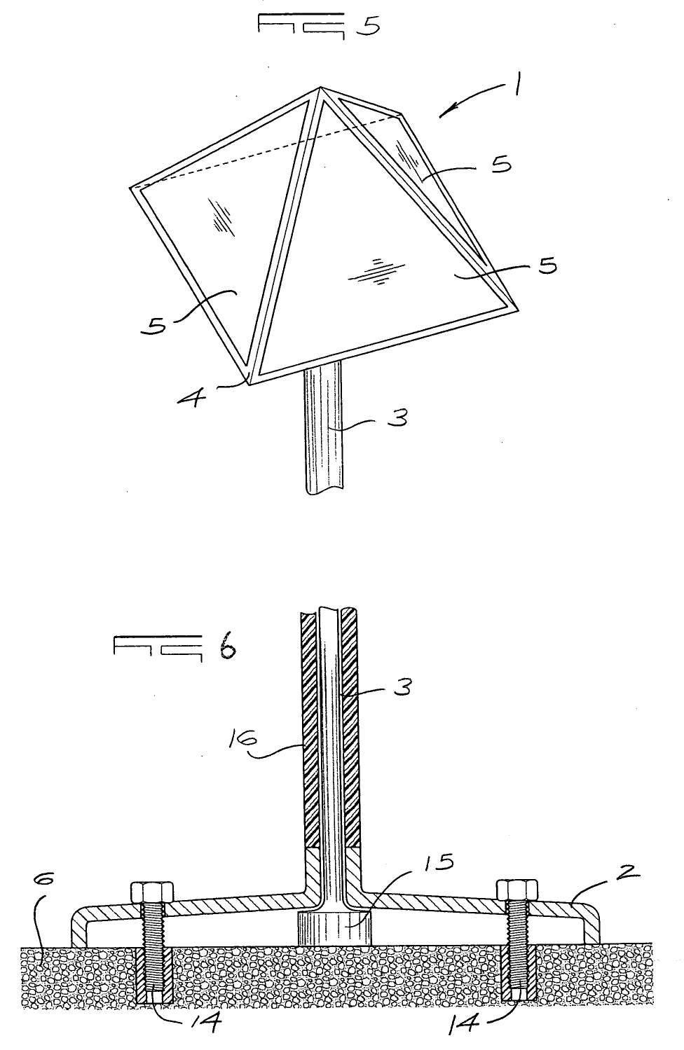

Referring now to FIGS. 3, 4 and 5, a standard (1) comprises a base (not shown) supporting an upright (3) which has a display means (4) located opposite the base (not shown). The display means (4) in FIG. 3 is parallelepipedical in shape and has five information displaying surfaces (5) although the operatively information displaying surface (13) may be fitted with solar cells which drive a mechanism causing the display means (5) to rotate about the axis of the upright (3). The display means (4) in FIG. 4 is triangular in cross section and has four information displaying surfaces (5) and, again, the operatively upper surface (13) may be fitted with solar cells. Referring specifically to FIG. 5, in this embodiment, the display means (4) is pyramidical in shape and has four information displaying surfaces (5).

Referring specifically to FIG. 6, an alternate embodiment of a standard base (2) and upright (3) is illustrated. In this embodiment the base (2) is moulded from a synthetic plastics material and it is circular in plan view. The base is secured to a surface (6) of a parking area between parking spaces for vehicles (not shown) by bolting it into rawl bolts or anchors (14). The upright (3) is formed from a length of resilient synthetic glass reinforced plastic and has a head (15) which is located within the base (2) such that it cannot be removed without unbolting the base (2) from the surface (6). The upright (3) is clad with a tubular, impact resistant synthetic rubber material (16).

It will be appreciated that, in addition to those described above, many variations can be made to the above-described embodiments of the invention without departing from the scope thereof. Thus, for example, the hinged sections of the upright may have a coil spring or a flexible rubber section. Insofar as the display means is concerned, a back-projection apparatus or even an advancing mechanism for a magazine of paper slides which are sequentially displayed for a predetermined time period may be used.

1. A standard comprising a base supporting an upright which has a display means located opposite the base, the display means having at least one surface on which information is displayed, the standard being locatable between contiguous vehicle parking bays in a parking area.

2. A standard as claimed in claim 1 in which the contiguous parking bays share an edge normally located towards the front of parked vehicles.

3. A standard as claimed in claim 1 in which the display means has two opposed surfaces on which information is displayed.

4. A standard as claimed in claim 1 in which the display means is cylindrical and has a circular surface on which information is displayed.

5. A standard as claimed in claim 1 in which the display means to be parallelepipedical and has five surfaces on which information can be displayed

6. A standard as claimed in claim 1 in which pyramidical and has four surfaces on which information can be displayed.

7. A standard as claimed in any one of claims claim 1 to 6 in which the information is selected from the group comprising: position related information in the form of directions and/or a map; communication related information in the form of directions to, for example, a departure and/or arrivals area of an airport or railway station; or advertising or marketing information.

8. A standard as claimed in any one of claims 1 to 7 in which the base of the standard is secured, in use, to a parking area substrate by means of a suitable fasteners and for at least the upright of the standard to have a means for obviating damage to a vehicle that, accidentally, bumps against the standard.

9. A standard as claimed in claim 8 in which the suitable fasteners are selected from the group comprising: rawl bolts, anchors and screws.

10. A standard as claimed in any one of claims 1 to 7 in which the base of the standard is secured, in use, to a parking area substrate by means of a suitable adhesive and for at least the upright of the standard to have a means for obviating damage to a vehicle that, accidentally, bumps against the standard.

11. A standard as claimed in any one of claims claim 8 to 10 in which the means for obviating damage to a vehicle that, accidentally, bumps against the standard is selected from the group comprising: a hinge mechanism and a spring mechanism.

12. A standard as claimed in claim 8 or in claim 10 in which the standard upright is manufactured of a resiliently flexible material and is clad with a synthetic, impact resistant, rubber material.

13. A standard as claimed in any one of the preceding claims in which the display means of the standard has a mechanism for varying the information displayed.

14. A standard as claimed in claim 13 in which the mechanism for varying the information displayed is an endless scroll and a driving mechanism.

15. A standard as claimed in claim 13 in which the mechanism for varying the information displayed is a means for rotating the display means on the standard upright.

16. A standard as claimed in claim 13 in which the information is displayed on an electronic image displaying screen.
